(19) United States
(12) Patent Application Publication
(10) Pub. No.: US 2014/0033877 A1
(43) Pub. Date: Feb. 6, 2014

(54) ADJUSTABLE HANDLE FOR DRIVING TOOL

(71) Applicant: Jack LEE, Taichung (TW)

(72) Inventor: Jack LEE, Taichung (TW)

(21) Appl. No.: 13/562,625

(22) Filed: Jul. 31, 2012

(51) Int. Cl. B25B 23/16; B25B 13/46

(52) U.S. Cl. 81/60; 81/177.8

(57) ABSTRACT

A driving tool includes a driving head having a catching element formed in a compartment of the driving head, a carrier includes a stem engaged in the driving head and slidable relative to the driving head between a working and engaging position and a releasing position, a latching member is formed on the stem for engaging with the catching element to selectively latch the stem and the carrier to the driving head, and the stem and the carrier are rotatable relative to the driving head when the latching member of the stem is disengaged from the catching element of the driving head and when the stem and the carrier are positioned to the driving head at the releasing position.

### BACKGROUND OF THE INVENTION

1. Field of the Invention

The present invention relates to a driving tool device, and more particularly to a driving tool device including a driving handle device rotatable and adjustable relative to a driving member or head to different angular direction for allowing the driving tool device to be easily and effectively rotated or driven by the driving handle device in different working environments or situations.

2. Description of the Prior Art

Typical driving tools, such as driving wrenches comprise a driving member or head, and a driving handle device connected or coupled to the driving member or head directly or indirectly for rotating or driving the driving member or head in order to actuate or drive or operate or rotate or drive the tool extensions, fasteners or the like with the driving member or head.

For example, U.S. Pat. No. 5,694,818 to Nickipuck, U.S. Pat. No. 6,000,299 to Cole, U.S. Pat. No. 6,032,555 to Whitley, U.S. Pat. No. 6,161,982 to Cole, U.S. Pat. No. 6,752,048 to Chiang, U.S. Pat. No. 6,993,998 to Kao et al., and U.S. Pat. No. 7,104,165 to Chu disclose several of the typical driving wrench tools each comprising a driving handle separated from a driving member or head and indirectly connected or coupled to the driving member or head for rotating or driving the driving member or head with the driving handle.

However, the driving handle of the typical driving wrench tools may not be pivoted or rotated or adjusted relative to the driving member or head horizontally to different lateral angular direction, and/or may not be pivoted or rotated or adjusted relative to the driving member or head vertically to different angular direction such that the driving member or head may not be easily and effectively rotated or driven by the driving handle particularly in the tiny working spaces or environment.

The present invention has arisen to mitigate and/or obviate the afore-described disadvantages of the conventional driving wrench tools.

### SUMMARY OF THE INVENTION

The primary objective of the present invention is to provide a driving tool device including a driving handle device rotatable and adjustable horizontally relative to the driving member or head to different lateral and angular direction for allowing the driving tool to be easily and effectively rotated or driven by the driving handle device in different working environments or situations.

The other objective of the present invention is to provide a driving tool device including a driving handle device rotatable and adjustable up and down or vertically relative to the driving member or head to different angular direction for allowing the driving tool to be easily and effectively rotated or driven by the driving handle device in different working environments or situations.

In accordance with one aspect of the invention, there is provided a driving tool comprising a driving head including a compartment formed therein, and including a catching element formed and provided in the compartment of the driving head, a latching device including a carrier having a stem extended downwardly therefrom and rotatably and slidably received and engaged in the compartment of the driving head and slidable along and relative to the compartment of the driving head between a working and engaging position and a releasing position, a latching member formed on the stem for selectively engaging with the catching element of the driving head and for selectively latching the stem and the carrier to the driving head and for allowing the driving head to be selectively rotated and driven by the stem and the carrier when the stem and the carrier are positioned to the driving head at the working and engaging position, and the stem and the carrier being rotatable and adjustable relative to the driving head when the latching member of the stem is disengaged from the catching element of the driving head and when the stem and the carrier are positioned to the driving head at the releasing position, a handle attached to the carrier, and a locking device attached to the latching device for selectively locking and retaining the stem and the carrier to the driving head either at the working and engaging position or at the releasing position, and the stem and the carrier and the handle are rotatable and adjustable horizontally relative to the driving head to different lateral angular direction before the latching member of the stem is mounted and engaged with the catching element of the driving head.

The catching element of the driving head is selected from an internal gear formed and provided in the compartment of the driving head. The latching member of the stem includes a non-circular cross section for selectively engaging with the internal gear of the driving head.

The driving head includes a first anchoring member and a second anchoring member formed therein and communicating with the compartment of the driving head, and the locking device includes a detent slidably received and engaged in the stem for selectively engaging with either of the first or the second anchoring member of the driving head and for selectively locking and anchoring or retaining the stem and the carrier to the driving head either at the working and engaging position or at the releasing position.

The first and the second anchoring members of the driving head are selected from inner peripheral grooves formed and provided in the driving head and communicating with the compartment of the driving head. The latching device includes a hole formed in the carrier and the stem, and an aperture formed in the stem and communicating with the hole for slidably receiving and engaging with the detent.

The latching device includes a rod slidably received and engaged in the hole of the carrier and the stem, and the rod includes an actuating member formed therein for slidably receiving and engaging with the detent and for selectively actuating the detent to engage with either of the first or the second anchoring member of the driving head. The actuating member of the rod is selected from a notch formed and provided in the rod.

The rod includes a button formed and provided thereon and extendible out of the carrier, and a spring biasing member engaged with the button and the carrier for biasing the button to move out of the carrier and for biasing the actuating member of the rod to engage with the detent.

The latching device includes a retaining ring attached to the rod and extended and located out of the carrier for selectively engaging with the carrier and for limiting the rod to slide and move relative to the carrier and for preventing the rod from being disengaged from the carrier.

The handle is pivotally attached to the carrier with a shaft for allowing the handle to be pivoted and rotated up and down or vertically relative to the carrier. The carrier includes a pair of flaps extended therefrom for forming and defining a slot between the flaps and for pivotally and rotatably receiving and attaching the handle.

The handle includes a first end portion pivotally and rotatably coupled to the carrier with the shaft, and includes a number of depressions formed in an outer peripheral portion of the first end portion of the handle, and the carrier includes a pawl slidably received and engaged therein for selectively engaging with either of the depressions of the handle and for selectively locking and retaining or positioning the handle to the carrier at a selected angular position.

The carrier includes a passage formed therein for slidably receiving and engaging with the pawl. The latching device includes a hole formed in the carrier and the stem, and a rod slidably received and engaged in the hole of the carrier and the stem, and the rod includes an actuating element formed therein for slidably receiving and engaging with the pawl. The actuating element of the rod is selected from a tilted or inclined notch formed and provided in the rod.

The rod includes a button formed and provided thereon and extendible out of the carrier, and the actuating element of the rod is formed and provided in the button of the rod for slidably receiving and selectively engaging with the pawl. The driving head includes a chamber formed therein for receiving and engaging with a driving cartridge.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a driving tool device in accordance with the present invention;

FIG. 2 is another partial exploded view of the driving tool device;

FIG. 3 is a further partial exploded view of the driving tool device;

FIG. 4 is a partial cross sectional view of the driving tool device, taken along lines 4-4 of FIG. 1;

FIGS. 5, 6 are partial cross sectional views similar to FIG. 4, illustrating the operation of the driving tool device; and

FIG. 7 is a partial top plan schematic view illustrating the operation of the driving tool.

### DETAILED DESCRIPTION OF THE PREFERRED EMBODIMENT

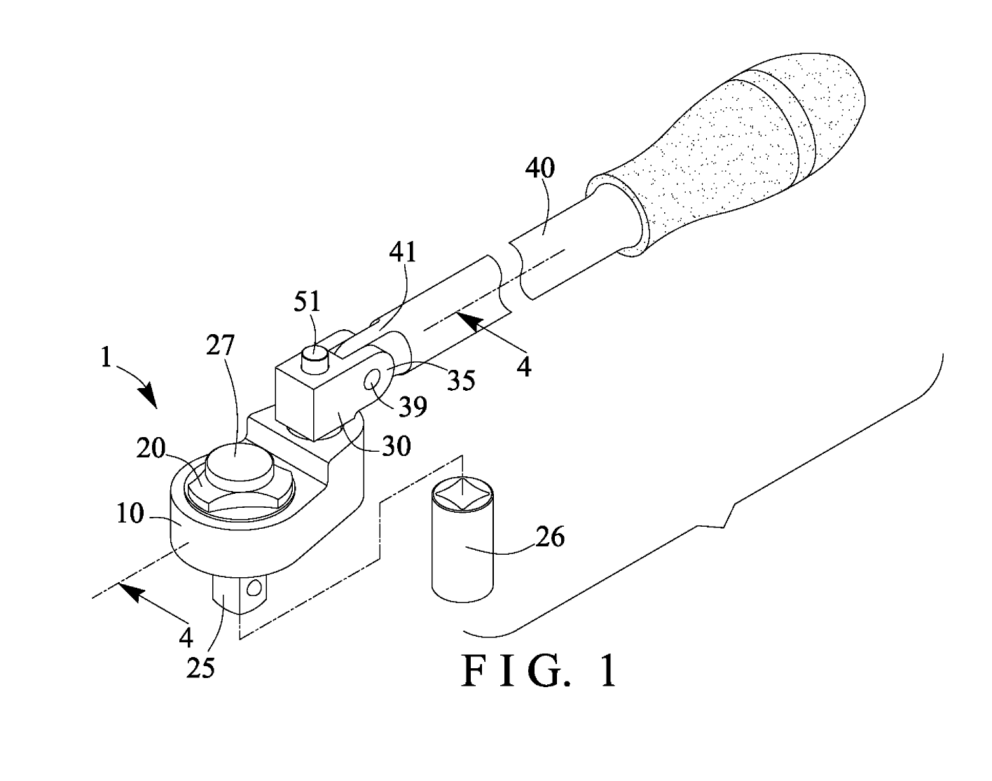

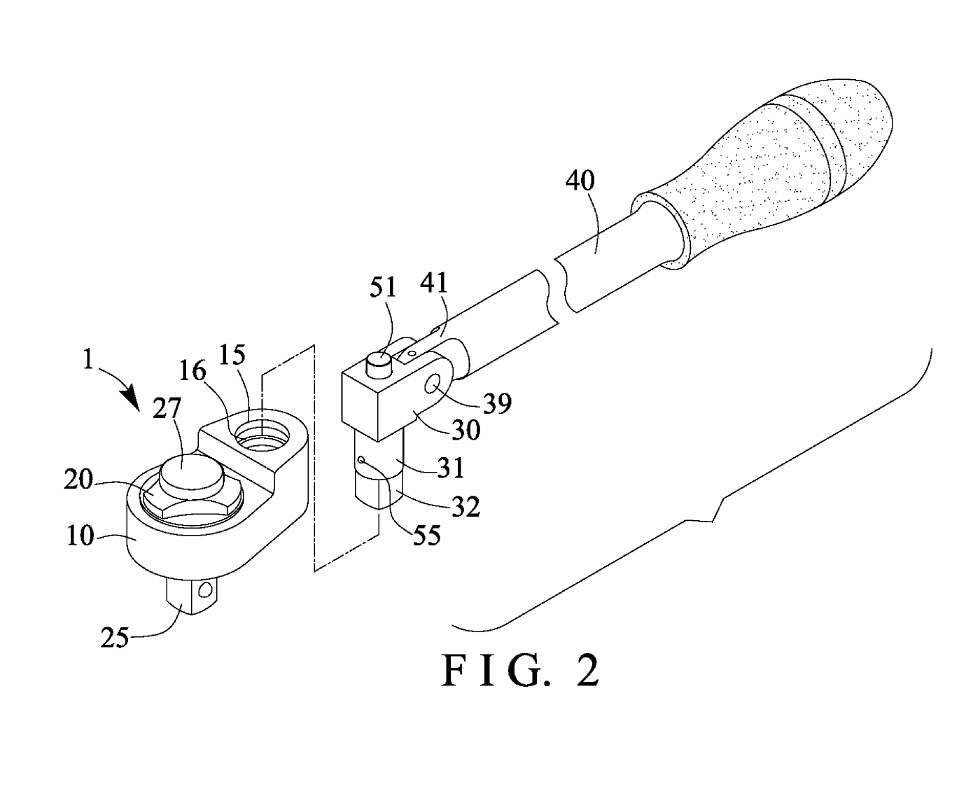

Referring to the drawings, and initially to FIGS. 1-4, a driving tool in accordance with the present invention comprises a driving device 1 including a driving member or head 10 having a bore or opening or chamber 11 formed therein, such as vertically formed therein, and/or having an internal gear 12 formed or provided therein for rotatably receiving or engaging with a driving cartridge 20 therein, and having an enlarged space or compartment 13 formed therein and communicating with the chamber 11 thereof, in which the compartment 13 of the driving head 10 includes an inner diameter greater than that of the chamber 11 of the driving head 10 for forming or defining an inner peripheral shoulder 14 in the driving head 10 and between the compartment 13 and the chamber 11 of the driving head 10.

For example, the driving cartridge 20 is rotatably received or engaged in or with the chamber 11 or the internal gear 12 of the driving head 10, and includes an enlarged upper element 21 rotatably received or engaged in the compartment 13 of the driving head 10 and extended radially and outwardly from the driving cartridge 20 for forming or defining a peripheral shoulder 22 in the driving cartridge 20 and for rotatably engaging with the inner peripheral shoulder 14 of the driving head 10 and thus for rotatably anchoring or retaining or positioning the driving cartridge 20 to the driving head 10 and for preventing the driving cartridge 20 from being moved axially or longitudinally relative to the driving head 10, and a clamping or retaining ring 23 may further be provided and attached or mounted or secured or coupled and engaged between the driving cartridge 20 and the driving head 10 for rotatably anchoring and retaining and coupling the driving cartridge 20 and the driving head 10 together.

The driving cartridge 20 further includes a spring biased projection or detent or pawl 24 disposed or attached or mounted or secured or engaged therein for selectively engaging with the internal gear 12 of the driving head 10 and for determining the rotating or driving direction of the driving cartridge 20 with or by the driving head 10, and includes a driving stem or shank 25 extended downwardly therefrom for selectively receiving or engaging with a tool extension, fastener, driven member 26, such as a socket 26 or the like and for allowing the driven member 26 to be pivoted or rotated in concert with the driving shank 25, and includes a button or hand grip or knob 27 formed or provided on top thereof for rotating or actuating or operating the driving cartridge 20 relative to the driving head 10. The above-described structure or configuration for the spring biased projection or pawl or detent 24 and the knob 27 is typical and is not related to the present invention and will not be described in further details.

The driving head 10 further includes a bore or chamber or opening or compartment 15 formed therein, such as vertically formed therein and offset from the chamber 11 thereof and parallel to the chamber 11 thereof for receiving or engaging with a locking or anchoring or latching device 3, and includes two retaining or positioning or anchoring portions or members 16, 17 formed or provided therein, such as an upper or first inner peripheral groove or anchoring member 16 and a relatively lower or middle or second inner peripheral groove or anchoring member 17 formed therein and communicating with the compartment 15 thereof, and another internal gear or locking or catching portion or member or element 18 formed or provided in the compartment 15 thereof and located below the relatively lower or middle anchoring member 17 of the driving head 10, and arranged such that the relatively lower or middle anchoring member 17 is disposed or located or positioned between the upper or first inner peripheral groove or anchoring member 16 and the internal gear or catching element 18 of the driving head 10.

The latching device 3 includes a body or block or seat or base or carrier 30 having a rod or stem 31 extended downwardly therefrom and pivotally or rotatably and slidably received or engaged in the compartment 15 of the driving head 10, a shank or locking or latching portion or element or member 32 further extended downwardly from the stem 31, or formed or provided on the stem 31 and located below the stem 31, and having a non-circular cross section for selectively engaging with the internal gear or catching element 18 of the driving head 10 and for selectively locking or latching or anchoring or retaining the stem 31 and the carrier 30 to the driving head 10 and for allowing the driving head 10 to be selectively pivoted or rotated or driven by the stem 31 and the carrier 30 when the latching member 32 of the stem 31 is engaged with the internal gear or catching element 18 of the driving head 10.

The latching device 3 includes a cavity or orifice or bore or stepped hole 33 formed therein, such as formed in or through the carrier 30 and the stem 31, and includes an aperture 34 formed therein, such as formed in the carrier 30 or the stem 31 and communicating with the stepped hole 33 thereof, and includes a pair of ears or flaps 35 extended laterally and outwardly therefrom for forming or defining a gap or slot 36 between the flaps 35, and includes a hole or cavity or orifice or passage 37 formed therein and communicating with the stepped hole 33 and the slot 36 thereof, and includes a hole or cavity or orifice or aperture or screw hole 38 formed in or through the flaps 35 and communicating with the slot 36 thereof for threading or engaging with a pin or axle or shaft 39 which is engaged with the flaps 35 and extended into or through the slot 36 thereof or straddled between the flaps 35, and preferably perpendicular to the X-axis and the Y-axis and the stem 31 of the carrier 30.

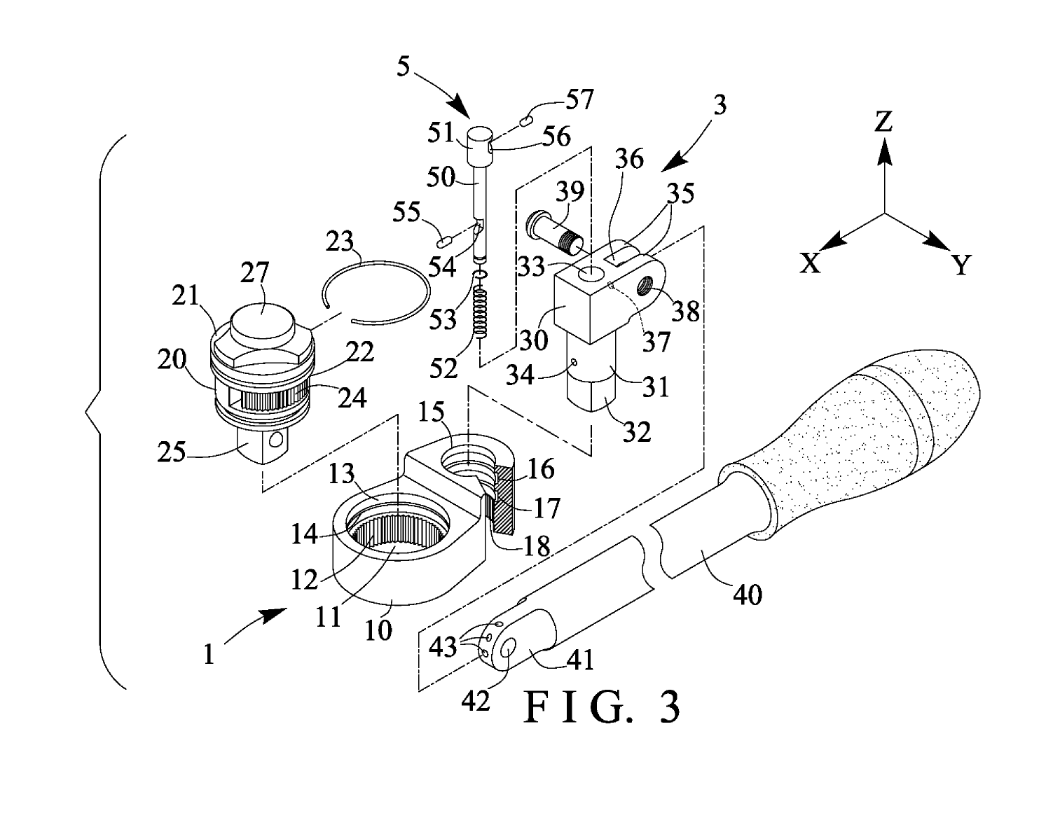

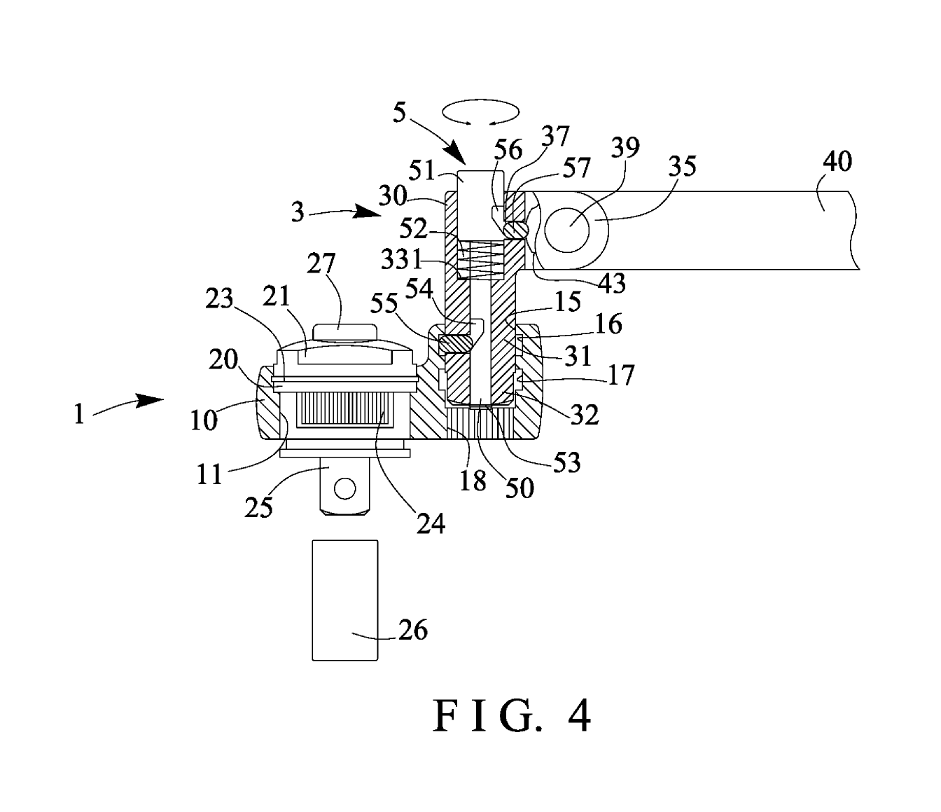

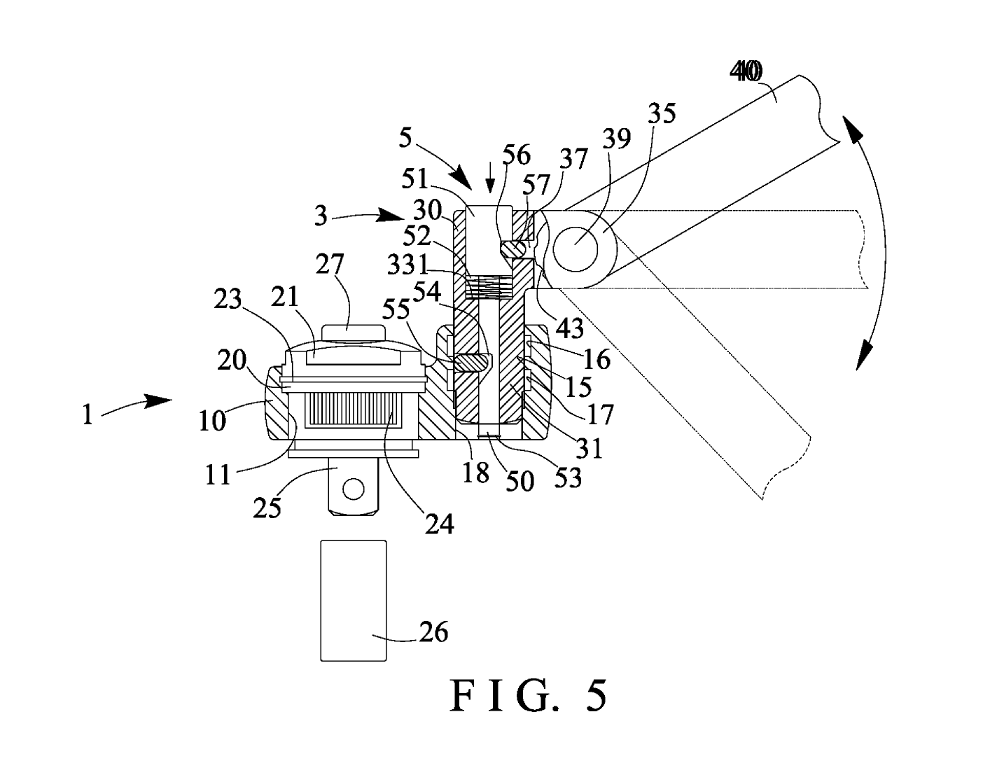

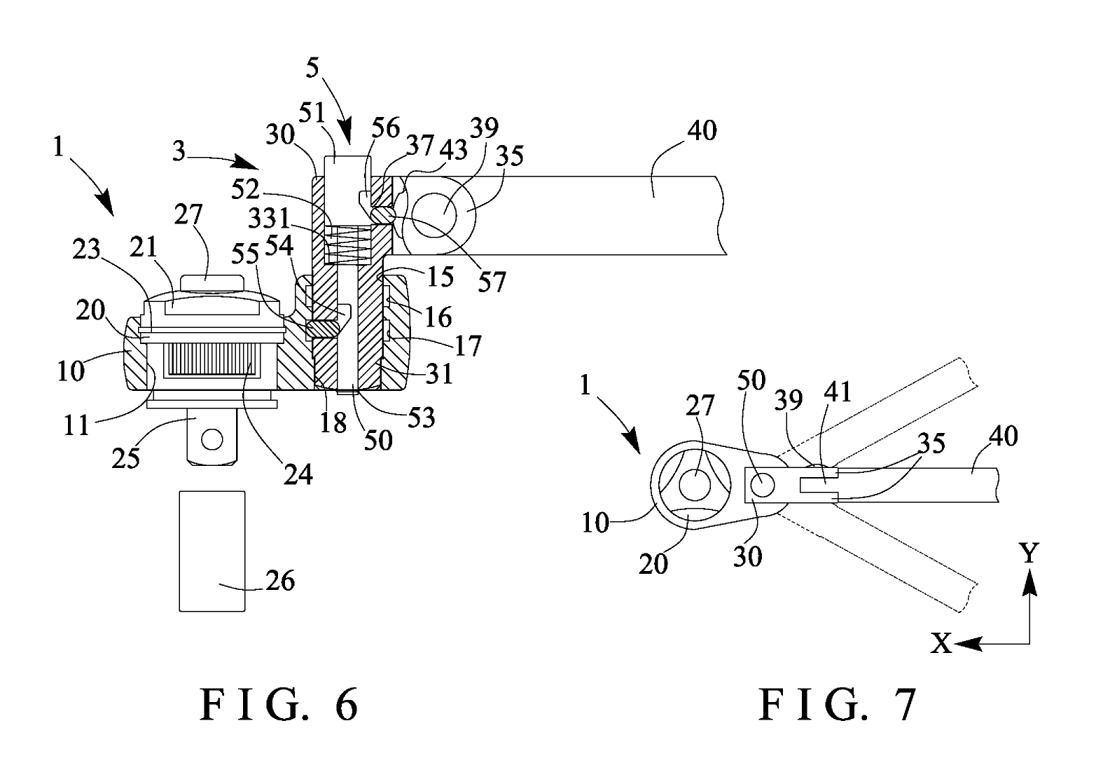

A handle 40 includes one end or first end portion 41 pivotally or rotatably engaged in the slot 36 of the carrier 30, and includes a hole or cavity or orifice 42 formed therein, such as formed in the one end 41 thereof for receiving or engaging with the shaft 39 and for pivotally or rotatably attaching or mounting or securing or coupling the handle 40 to the carrier 30 and for allowing the handle 40 to be pivoted or rotated relative to the carrier 30 and/or the driving head 10 with the shaft 39 in an X-Z plane (FIGS. 3, 5), and includes one or more recesses or depressions 43 formed in the outer peripheral portion of the one end 41 of the handle 40 for selectively directing or facing toward the passage 37 of the carrier 30 (FIGS. 4-6). It is to be noted that the handle 40 and/or the carrier 30 is pivotal or rotatable relative to the driving head 10 in an X-Y plane (FIG. 7) with the pivoting or rotating engagement of the stem 31 in the compartment 15 of the driving head 10.

The latching device 3 further includes a latching or catching or anchoring or locking device 5 attached to the latching device 3 and having a pole or rod 50 slidably received or engaged in the stepped hole 33 of the carrier 30 and/or the stem 31, and having an enlarged head or block or button 51 formed or provided on top of the rod 50 and also slidably received or engaged in the stepped hole 33 of the carrier 30 and slightly extendible out of the carrier 30 (FIGS. 1-2, 4, 6), a spring biasing member 52 is received or disposed or engaged into the stepped hole 33 of the carrier 30 and engaged with or between the button 51 and an inner peripheral shoulder 331 that is formed or provided in the stepped hole 33 of the carrier 30 for biasing and forcing or moving the button 51 upwardly or outwardly beyond the carrier 30, and a clamping or anchoring or retaining ring 53 is further provided and attached or mounted or secured to the free or bottom end of the rod 50 and extended or located out of the carrier 30 for selectively engaging with the carrier 30 (FIGS. 4, 6) and for limiting the rod 50 to slide and move relative to the carrier 30 and for preventing the rod 50 from being disengaged or separated from the carrier 30.

The locking device 5 further includes a tilted or inclined notch or actuating portion or member 54 formed therein, such as formed in the rod 50 and faced or directed forwardly toward the aperture 34 of the stem 31 or of the carrier 30 for slidably receiving or engaging with a pawl or detent 55 which is slidably received or engaged in the aperture 34 of the stem 31 or of the carrier 30 for selectively engaging with either of the anchoring members 16, 17 of the driving head 10 (FIGS. 4-6), and/or another tilted or inclined notch or actuating portion or element 56 formed therein, such as formed in the button 51 and faced or directed rearwardly toward the passage 37 of the carrier 30 for slidably receiving or engaging with a detent or pawl 57 which is slidably received or engaged in the passage 37 of the carrier 30 for selectively engaging with either of the depressions 43 at the one end 41 of the handle 40.

In operation, as shown in FIG. 5, when the button 51 of the rod 50 is depressed and forced to move into the stepped hole 33 of the carrier 30 and onto the spring biasing member 52, the detent 55 and the pawl 57 are receivable or engageable into the actuating member 54 and the actuating element 56 of the locking device 5 for allowing the stem 31 of the carrier 30 to slide or move up and down along the compartment 15 of the driving head 10 between an upper releasing position (FIG. 4) where the detent 55 is aligned with the upper or first inner peripheral groove or anchoring member 16 of the driving head 10 and where the latching member 32 is offset or separated or disengaged from the internal gear or catching element 18 of the driving head 10, and a lower working or engaging position (FIG. 6) where the detent 55 is aligned with the relatively lower or middle or second inner peripheral groove or anchoring member 17 of the driving head 10 and where the latching member 32 is meshed or engaged with the internal gear or catching element 18 of the driving head 10.

At this moment, when the pawl 57 is received or engaged into the actuating element 56 of the locking device 5 and disengaged from the one end 41 of the handle 40, the handle 40 is pivotable or rotatable relative to the carrier 30 and/or the driving head 10 with the shaft 39 in the X-Z plane (FIG. 5) and rotatable or adjustable up and down relative to the carrier 30 and/or the driving head 10 to different angular position and thus for allowing the carrier 30 and/or the driving head 10 to be easily and effectively pivoted or rotated or driven by the handle 40 in different working environments or situations. When the button 51 of the rod 50 of the locking device 5 is released, the spring biasing member 52 may bias and force and move the button 51 of the rod 50 out of the carrier 30 and may bias and force and actuate the pawl 57 to engage into or with either of the depressions 43 at the one end 41 of the handle 40 and thus to anchor or retain or position the handle 40 to the carrier 30 and/or the driving head 10 at the selected angular position.

Simultaneously, when the button 51 of the rod 50 of the locking device 5 is released, the spring biasing member 52 may also bias and force and actuate the detent 55 to engage into or with either of the anchoring members 16, 17 of the driving head 10. For example, when the detent 55 is engaged with the upper or first inner peripheral groove or anchoring member 16 of the driving head 10 (FIG. 4), the latching member 32 is offset or separated or disengaged from the internal gear or catching element 18 of the driving head 10 such that the stem 31 of the carrier 30 is allowed to pivot or rotate or adjust horizontally relative to the driving head 10 to different angular direction in the X-Y plane (FIG. 7) for allowing the driving tool to be easily and effectively rotated or driven or operated by the driving handle 40 in different working environments or situations.

As shown in FIG. 6, when the detent 55 is biased and forced to engage with the relatively lower or middle or second inner peripheral groove or anchoring member 17 of the driving head 10 and at the lower working or engaging position, the latching member 32 is meshed or engaged with the internal gear or catching element 18 of the driving head 10 for preventing the stem 31 of the carrier 30 from being pivoted or rotated relative to the driving head 10 and for allowing the driving head 10 to be pivoted or rotated or driven with or by the carrier 30 and the driving handle 40. Accordingly, the handle 40 is pivotable or rotatable or adjustable up and down relative to the carrier 30 and/or the driving head 10 in the X-Z plane (FIG. 5) and also pivotable or rotatable or adjustable horizontally relative to the carrier 30 and/or the driving head 10 to different angular direction in the X-Y plane (FIG. 7) for allowing the carrier 30 and/or the driving head 10 of the driving tool to be easily and effectively pivoted or rotated or driven by the driving handle 40 in different working environments or situations.

Accordingly, the driving tool in accordance with the present invention includes a driving handle device rotatable and adjustable relative to a driving member or head, and/or rotatable and adjustable vertically relative to the driving member or head to different angular direction for allowing the driving tool to be easily and effectively rotated or driven by the driving handle device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A driving tool comprising:
a driving head including a compartment formed therein, and including a catching element formed and provided in said compartment of said driving head,
a latching device including a carrier having a stem extended downwardly therefrom and rotatably and slidably received and engaged in said compartment of said driving head and slidable along and relative to said compartment of said driving head between a working and engaging position and a releasing position, a latching member formed on said stem for selectively engaging with said catching element of said driving head and for selectively latching said stem and said carrier to said driving head and for allowing said driving head to be selectively rotated and driven by said stem and said carrier when said stem and said carrier are positioned to said driving head at said working and engaging position, and said stem and said carrier being rotatable and adjustable relative to said driving head when said latching member of said stem is disengaged from said catching element of said driving head and when said stem and said carrier are positioned to said driving head at said releasing position,
a handle attached to said carrier, and
a locking device attached to said latching device for selectively locking and retaining said stem and said carrier to said driving head either at said working and engaging position or at said releasing position, and
said stem and said carrier and said handle being rotatable and adjustable horizontally relative to said driving head to different lateral angular direction before said latching member of said stem is engaged with said catching element of said driving head.

2. The driving tool as claimed in claim 1, wherein said catching element of said driving head is selected from an internal gear formed and provided in said compartment of said driving head.

3. The driving tool as claimed in claim 2, wherein said latching member of said stem includes a non-circular cross section for selectively engaging with said internal gear of said driving head.

4. The driving tool as claimed in claim 1, wherein said driving head includes a first anchoring member and a second anchoring member formed therein and communicating with said compartment of said driving head, and said locking device includes a detent slidably received and engaged in said stem for selectively engaging with either of said first or said second anchoring member of said driving head and for selectively locking and retaining said stem and said carrier to said driving head either at said working and engaging position or at said releasing position.

5. The driving tool as claimed in claim 4, wherein said first and said second anchoring members of said driving head are selected from inner peripheral grooves formed and provided in said driving head and communicating with said compartment of said driving head.

6. The driving tool as claimed in claim 4, wherein said latching device includes a hole formed in said carrier and said stem, and an aperture formed in said stem and communicating with said hole for slidably receiving and engaging with said detent.

7. The driving tool as claimed in claim 6, wherein said latching device includes a rod slidably received and engaged in said hole of said carrier and said stem, and said rod includes an actuating member formed therein for slidably receiving and engaging with said detent.

8. The driving tool as claimed in claim 7, wherein said actuating member of said rod is selected from a notch formed and provided in said rod.

9. The driving tool as claimed in claim 7, wherein said rod includes a button formed and provided thereon and extendible out of said carrier, and a spring biasing member engaged with said button and said carrier for biasing said button to move out of said carrier and for biasing said actuating member of said rod to engage with said detent.

10. The driving tool as claimed in claim 7, wherein said latching device includes a retaining ring attached to said rod and extended and located out of said carrier for selectively engaging with said carrier and for limiting said rod to slide and move relative to said carrier and for preventing said rod from being disengaged from said carrier.

11. The driving tool as claimed in claim 1, wherein said handle is pivotally attached to said carrier with a shaft for allowing said handle to be pivoted and rotated up and down relative to said carrier.

12. The driving tool as claimed in claim 11, wherein said carrier includes a pair of flaps extended therefrom for forming and defining a slot between said flaps and for pivotally and rotatably receiving and attaching said handle.

13. The driving tool as claimed in claim 11, wherein said handle includes a first end portion pivotally and rotatably coupled to said carrier with said shaft, and includes a plurality of depressions formed in an outer peripheral portion of said first end portion of said handle, and said carrier includes a pawl slidably received and engaged therein for selectively engaging with either of said depressions of said handle and for selectively locking and retaining said handle to said carrier at a selected angular position.

14. The driving tool as claimed in claim 13, wherein said carrier includes a passage formed therein for slidably receiving and engaging with said pawl.

15. The driving tool as claimed in claim 13, wherein said latching device includes a hole formed in said carrier and said stem, and a rod slidably received and engaged in said hole of said carrier and said stem, and said rod includes an actuating element formed therein for slidably receiving and engaging with said pawl.

16. The driving tool as claimed in claim 15, wherein said actuating element of said rod is selected from a notch formed and provided in said rod.

17. The driving tool as claimed in claim 15, wherein said rod includes a button formed and provided thereon and extendible out of said carrier, and said actuating element of said rod is formed and provided in said button of said rod.

18. The driving tool as claimed in claim 1, wherein said driving head includes a chamber formed therein for receiving and engaging with a driving cartridge.
